(19) United States
(12) Patent Application Publication
(10) Pub. No.: US 2016/0149987 A1
(43) Pub. Date: May 26, 2016

(54) METHODS, SYSTEMS, AND COMPUTER READABLE MEDIA FOR AUTOMATIC GENERATION OF PROGRAMMING-LANGUAGE-NEUTRAL REPRESENTATION OF WEB APPLICATION PROTOCOL INTERACTIONS THAT IMPLEMENT NETWORK TEST

(71) Applicant: lxia, Calabasas, CA (US)

(72) Inventor: Lyle Eugene Thompson, Thousand Oaks, CA (US)

(21) Appl. No.: 14/552,428

(22) Filed: Nov. 24, 2014

(51) Int. Cl. H04L 29/08; H04L 29/06

(52) U.S. Cl. CPC H04L 67/02; H04L 69/08

(57) ABSTRACT

The subject matter described herein includes methods, systems, and computer readable media for generating a programming-language-neutral representation of web application protocol interactions that implement a network test. One method includes receiving, at a web server, test configuration information for configuring a test for testing at least one network device. The method further includes generating, based on the test configuration information a programming-language-neutral representation of web application protocol interactions that implement the test. The method further includes outputting the representation of the web application protocol interactions to a user or to a translator for translation into at least one target programming language.

### TECHNICAL FIELD

The subject matter described herein relates to testing network devices. More particularly, the subject matter described herein relates to methods, systems, and computer readable media for automatic generation of a programming-language-neutral representation of web application protocol interactions that implement a network test.

### BACKGROUND

Scripts are often written by test engineers or are automatically generated in a target programming language to test network devices. Because many network devices that need to be tested operate in data networks, such as the Internet, it is desirable to create test scripts that emulate data network devices, such as clients and servers and that conform to protocols or that control frameworks for that, in turn, emulate data network devices. One example of such a framework can be scripted using representational state transfer (REST). REST is a protocol for interactions between clients and servers where all of the state necessary to process a given request is contained within the request itself. REST is not a programming language—it merely specifies a framework that developers can follow when creating web services. A web server that complies with REST is said to be RESTful.

Existing test script generators generate scripts directly in a target programming language, such as Python or tool command language (TCL). Such script generators are hard coded to the target programming language. As a result, if it is desirable to create a test in a new programming language, the test script generator must be reprogrammed to generate output in the new programming language. Requiring reprogramming of a test script generator for each target programming language makes such a solution unscalable.

Accordingly, in light of these difficulties, there exists a need for methods, systems, and computer readable media for automatically generating a programming-language-neutral representation of web application protocol interactions that implement a test and that can be easily translated into a plurality of different target programming languages.

### SUMMARY

The subject matter described herein includes methods, systems, and computer readable media for generating a programming-language-neutral representation of web application protocol interactions that implement a network test. One method includes receiving, at a web server, test configuration information for configuring a test for testing at least one network device. The method further includes generating, based on the test configuration information, a programming-language-neutral representation of web application protocol interactions that implement the test. The method further includes outputting the representation of the web application protocol interactions to a user or to a translator for translation into at least one target programming language.

The subject matter described herein may be implemented in software in combination with hardware and/or firmware. For example, the subject matter described herein may be implemented in software executed by a processor. In one exemplary implementation, the subject matter described herein may be implemented using a computer readable medium having stored thereon computer executable instructions that when executed by the processor of a computer control the computer to perform steps. Exemplary computer readable media suitable for implementing the subject matter described herein include non-transitory devices, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

The subject matter described herein will now be explained with reference to the accompanying drawings of which:

FIG. 1 is a block diagram illustrating a system for automatically generating a programming-language-neutral representation of web application protocol interactions that implement a test according to an embodiment of the subject described herein;

FIG. 2 is a block diagram illustrating a system for automatically generating a programming-language-neutral representation of web application protocol interactions that implement a test according to an alternate embodiment of the subject matter described herein;

FIG. 3 is a flow chart illustrating an exemplary process for automatically generating a programming-language-neutral representation of web application protocol interactions that implement a test according to an embodiment of the subject matter described herein; and

FIGS. 4 through 9 are computer screen shots illustrating exemplary graphical user interfaces for receiving a test configuration that may be used to generate a programming-language-neutral representation of web application protocol interactions that implement a network test according to an embodiment of the subject matter described herein.

### DETAILED DESCRIPTION

The subject matter described herein includes methods, systems, and computer readable media for automatically generating a programming-language-neutral representation of web application protocol interactions that implement a network test. In one implementation, the web application protocol is the REST protocol and the examples described herein are based on the REST protocol. However, it should be understood that other web application protocols or frameworks can be used without departing from the scope of the subject matter described herein.

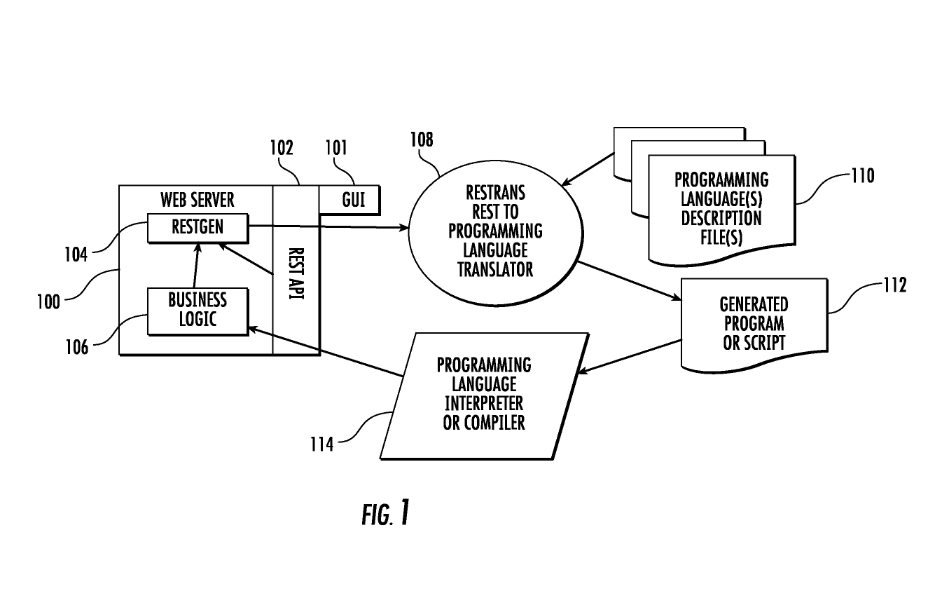

FIG. 1 is a block diagram illustrating an exemplary system for automatically generating a programming-language-neutral representation of web application protocol interactions that implement a test according to an embodiment of the subject matter described herein. Referring to FIG. 1, a web server 100 includes a graphical user interface (GUI) 101 through which a user configures tests for testing network equipment. GUI 101 is usable to invoke RESTful services via application programming interface (API) 102, which communicates the selected services to web application protocol interaction symbolic representation generator 104. Web application protocol interaction symbolic representation generator 104 generates a programming-language-neutral representation of web application protocol interactions that implement a test based on input received from the user via GUI 101 and/or web application protocol API 102. Web server 100 further includes business logic 106 that executes test scripts created from the symbolic representations generated by symbolic representation generator 104 and the test scripts may interact with test scripts also generated by symbolic representation generator 104 and that execute on remote devices. GUI 101 may also be usable to configure tests using an internal API, which both API 102 (REST API) and GUI 101 may use.

Before a test can be executed, the test must be translated from the symbolic representation of the web application protocol interactions to a target programming language. In the examples described herein, the target programming language is a scripting language, such as Python or TCL. The translator for translating from the symbolic representation to the target programming language may be located on web server 100 or externally to web server 100. In the example illustrated in FIG. 1, the symbolic representation to target programming language translator 108 is located externally to web server 100 and translates the symbolic representation of the web application protocol interactions, such as REST interactions, to scripts 112 written in target programming languages using programming language description files 110. In such an implementation, translator 108 may be a generic translator that can be updated to translate to new target programming language simply by providing a new programming language description file 110 for the new programming language. Thus, programming language description files 110 may function as templates that configure translator 108 to generate test program in any of a plurality of different target programming languages from a single programming-language-neutral representation. In an alternate implementation, a plurality of programming-language-specific translators 108 may be provided. Programming-language-specific translators 108 may be manually written by users or automatically generated from template files for each programming language.

In one mode of operation, translator 108 may download files from server 100 that contain the symbolic representations of the RESTful interactions that implement a test, read the symbolic representations from the files, and generate the target programming language script selected by a user. A given file may be downloaded, for example, in response to user input to translator 108 to download a specific file. In an alternate implementation, translator 108 may operate in an active mode where translator 108 monitors output from server 100 and automatically initiates a translation from the symbolic representation to the target programming language in response to being instructed to do so by server 100.

Once a script is generated in the target programming language, the script may be provided to a programming language interpreter or compiler 114 for generation of executable code. In one example, the executable code is a test program for testing one or more devices under test. As a result, the executable code may be loaded onto a remote computer that generates REST interactions with web server 100. Such interactions may be used to test server 100 and/or one or more devices (switches, routers, firewalls, etc.) between the remote computer and server 100.

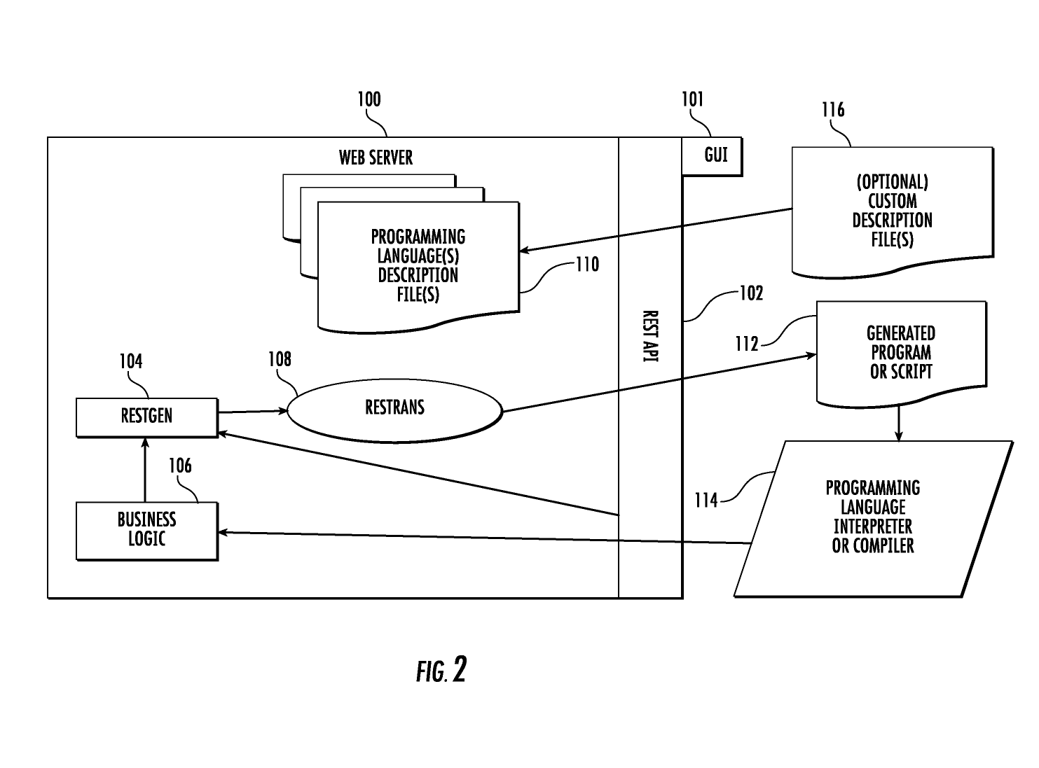

In FIG. 1, translator 108 is external to server 100. In an alternate embodiment of the subject matter described herein, translator 108 may be internal to server 100. FIG. 2 illustrates such an embodiment. In FIG. 2, symbolic representation generator 104 generates the symbolic representation of the web application protocol interactions as described above. Translator 108 internal to web server 100 translates the symbolic representation into the target programming language using programming language description files 110. The functionality of translator 108 can be easily updated (i.e., without reprogramming and recompiling translator 108) to generate test scripts in new target programming languages by uploading custom description files 116 to server 100. Compiler 114 compiles the target programming language code into an executable file that implements business logic 106, which may be used to test one or more devices under test.

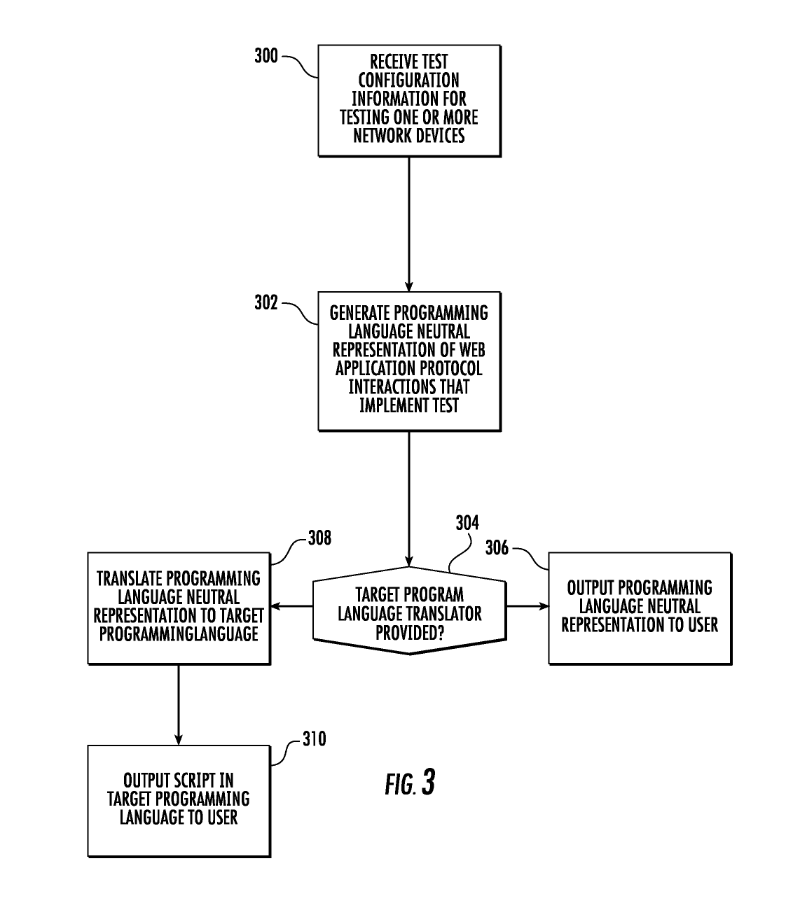

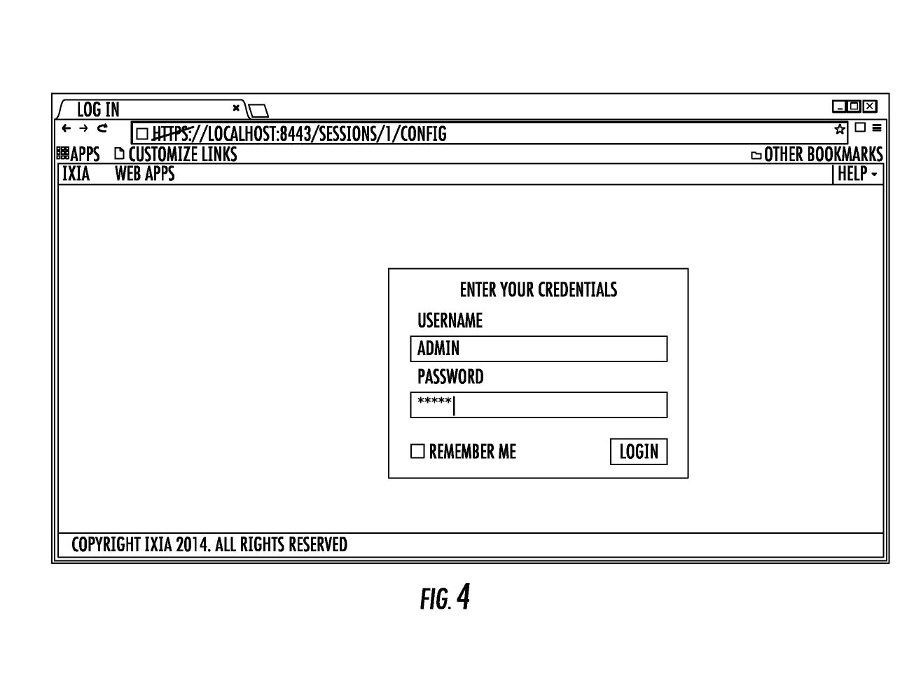

FIG. 3 is a flow chart illustrating an exemplary process for automatic generation of web application protocols script according to an embodiment of the subject matter described herein. Referring to FIG. 3, in step 300, a web server receives test configuration information for configuring a test for testing at least one network device. The test configuration information, in one embodiment, may be received by providing a graphical user interface that allows the user to graphically design a test. FIGS. 4 through 9 illustrate an example of a graphical user interface according to an embodiment of the subject matter described herein. In FIG. 4, the user logs in to server 100 by providing the user's credentials. In response to the input illustrated in FIG. 4, symbolic representation generator 104 generates a symbolic representation of the interactions with web server 100, which for the example illustrated in FIG. 4 may appear as follows:

| CREDENTIALS username:${prompt} password:${prompt} | |
|---|---|
| CONNECT url:“http://ixia.customer.com” apiVersion:”v1” | |
| CHECKVERSION Server:2.4 | // Unique to scripting |

The above-listed symbolic representation illustrates interactions associated with logging in and connecting to a web server on which a test will be designed and subsequently executed. The ${prompt} notation indicates to the program generation logic to generate code to request and accept input from the user and replace the ${prompt} notation with the user's input.

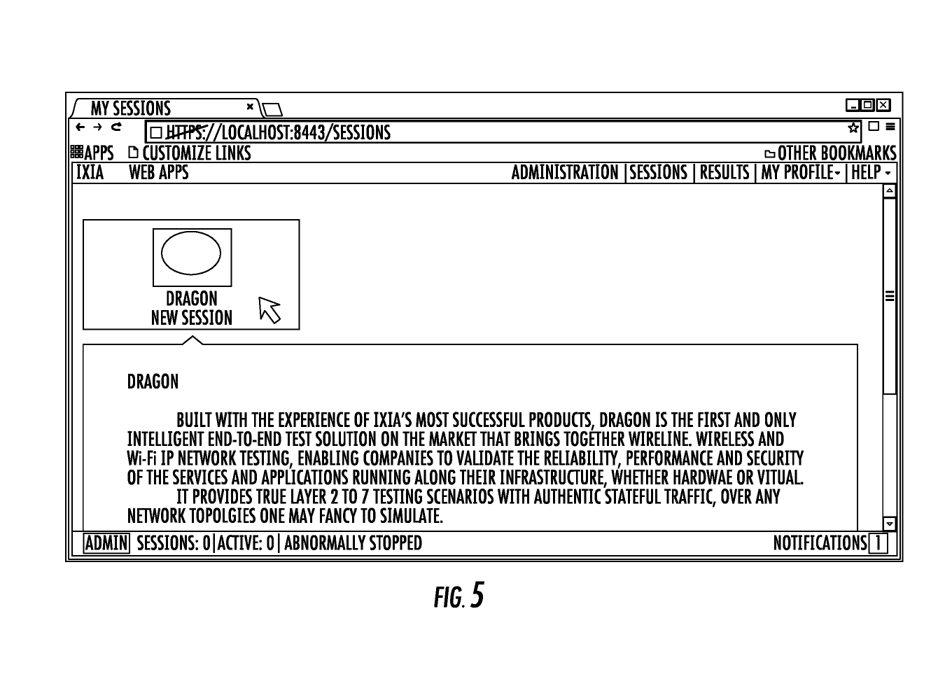

After entering the credentials in FIG. 4, the user interface displays a list of session types and the user is permitted to select one of the session types. FIG. 5 illustrates the user's selection of a “dragon” session type, which is a session type through which the user can create one or more tests for testing network devices. While only a single session type is illustrated in FIG. 5, multiple different session types may be displayed, or a session type can be automatically selected without departing from the scope of the subject matter described herein. Once the user selects the dragon session type in FIG. 5, symbolic representation generator 104 generates the following (or similar) symbolic representation of the user interactions with the graphical user interface:
CREATESESSION “dragon”
   The above-listed script indicates that a dragon session is being created.

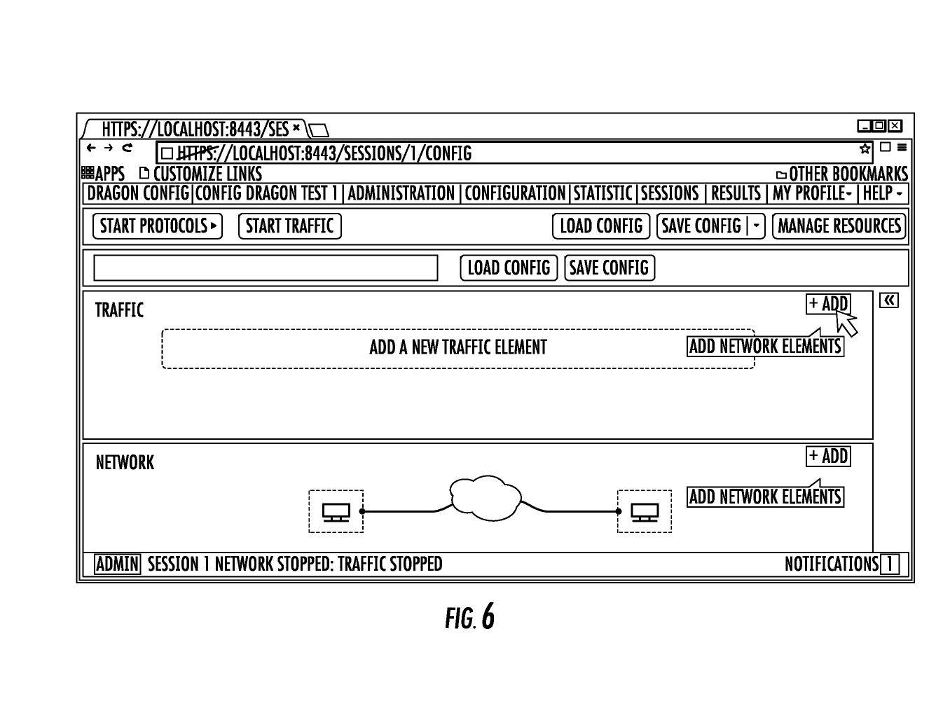

After the user has selected the option for creating the dragon session, GUI 101 presents the user with test configuration options for testing one or more network devices. FIG. 6 illustrates an example of a test configuration interface that may be presented to the user. In FIG. 6, the upper portion of the screen allows the user to select a new traffic element. The lower portion of the screen illustrates network endpoints and the cloud represents one or more devices under test. For each traffic element that the user selects, symbolic representation generator 104 generates the following symbolic representation of the user's interactions with the graphical user interface:
APPEND “${Session.url}/config/traffic/elements}”
   The above-listed symbolic representation may be repeated multiple times for each traffic element that the user defines. In the above-referenced symbolic representation, the element $(Session.url) is a symbolic element that is replaced with data that is dynamically obtained as part of the interaction with server 100. In this case, the data would be the URL for the server endpoint of the current session with server 100.

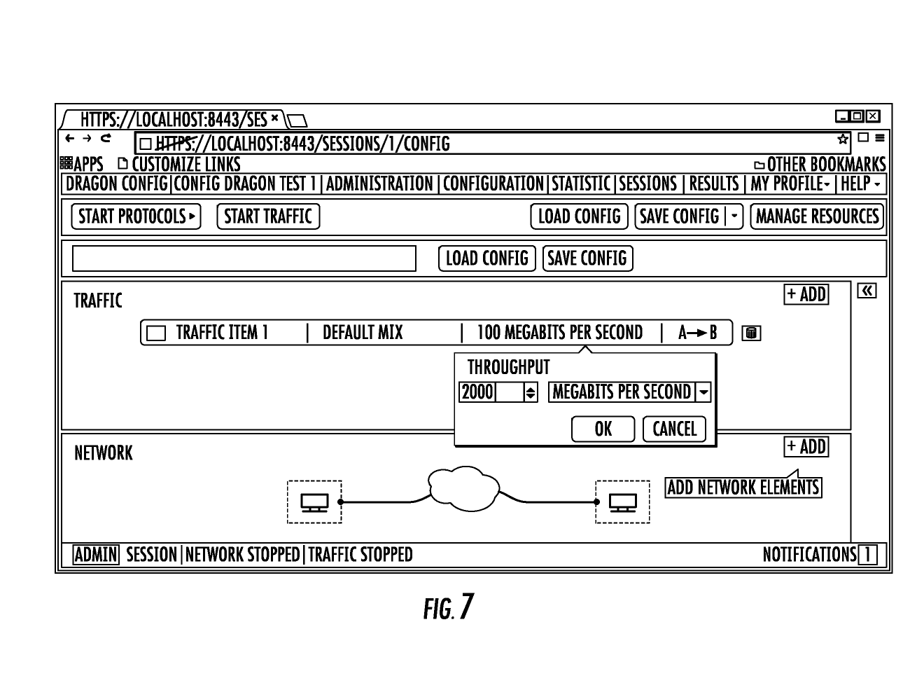

After the user has defined a traffic element, the user may modify one or more aspects of the traffic element to define the type and mix of traffic that is sent to the device under test. FIG. 7 illustrates the definition of a traffic element by specifying throughput in megabits per second. Once the user modifies or defines the throughput using the interface illustrated in FIG. 7, symbolic representation generator 104 generates the following symbolic representation:
MODIFY ${Session.url}/config/traffic/elements/1/throughput}{rate:“100”}
   The above-listed instruction indicates that the user is modifying the throughput for an element of a test to be 100 megabits per second.

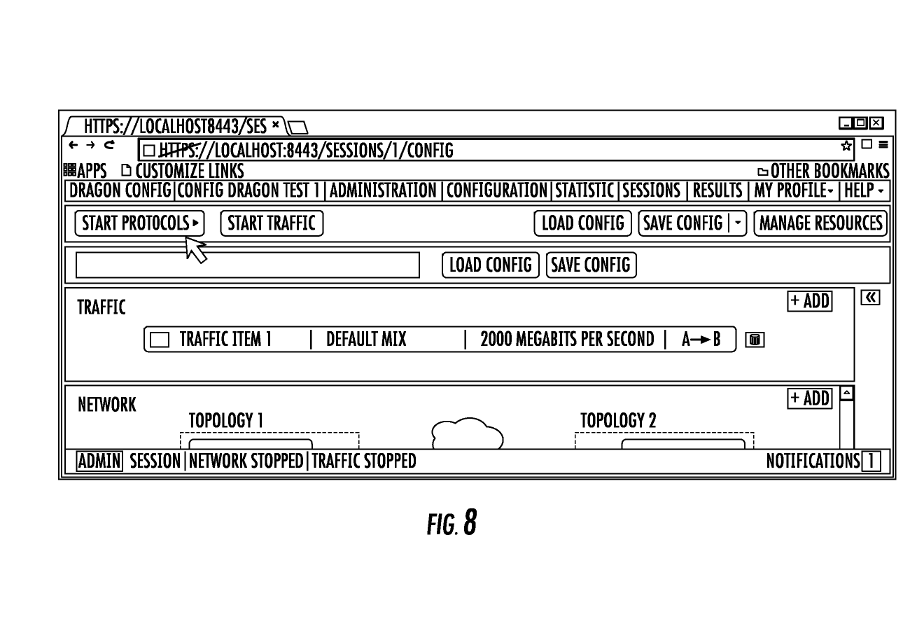

After defining the traffic elements in a test, the user may select the start protocols button, which initiates a test. FIG. 8 illustrates user selection of the start protocols button and in response to the user selecting the start protocols button, symbolic representation generator 104 generates the following script:
START_PROTOCOLS
   The above-listed command indicates that the protocols defined for the test are being started for the test that is about to be implemented.

After starting the protocols, the user may run the test that sends traffic over the network to the device under test by selecting a “Start Traffic” button. The following script may be generated in response to user selection of the “Start Traffic” button.
START_TRAFFIC

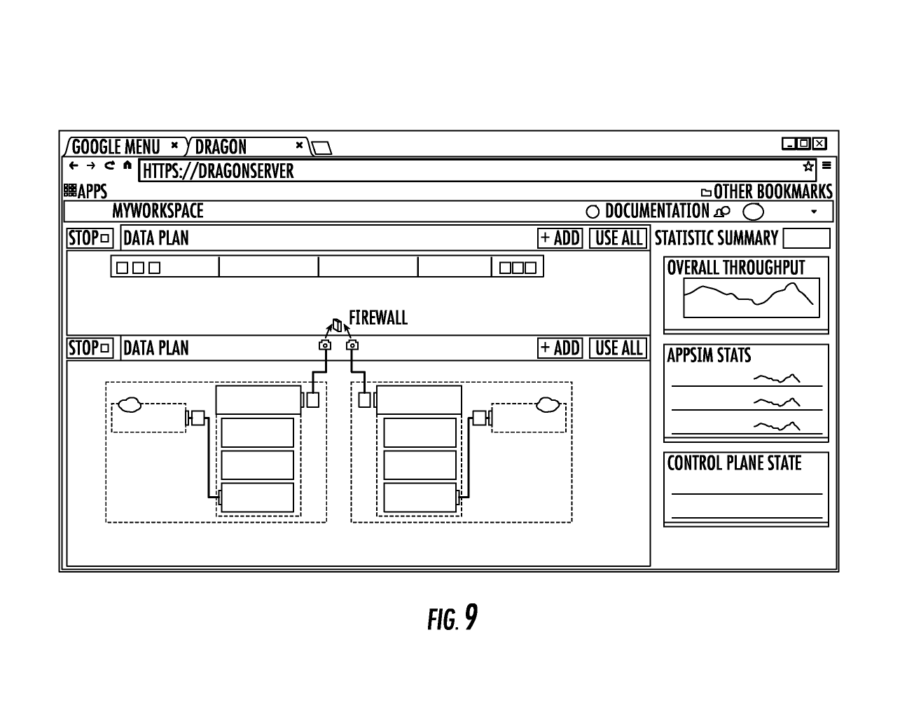

As a default option, server 100 may display statistics of the test to the user. FIG. 9 illustrates exemplary statistics that may be displayed after a test is executed. In FIG. 9, the statistics include overall throughput, application simulation statistics, and control plane statistics. When the user selects the stop protocols button in FIG. 8, the test stops. In response to receiving the stop protocols button, the following symbolic representation may be generated:
WAIT 30 //the time between the user clicking start traffic and stop protocols STOP_PROTOCOLS
   The above-listed command indicates that the test is to be stopped. In some embodiments, the simple timed wait command above could be replaced with symbolic representation to effectuate a wait for a specific condition arising from the execution of the test, for example to watch for certain patterns in the statistics before stopping the test.

The remainder of the symbolic representation that may be generated by symbolic representation generator 104 is the following command, which is a default option for generating statistics:
GETSTATS format:“CSV” stats:“*” destinationFolder:“C:/”
   The above-listed symbolic command indicates that statistics generated during a test will be stored in a destination folder.

Returning to FIG. 3, in step 302, a programming-language-neutral representation of web application protocol interactions that implement the test is generated based on the user input. Examples of the programming-language-neutral representation of the web application protocol interactions are provided above with respect to each of FIGS. 4-9. The following example contains the entire symbolic representation that may be generated in response to the user input illustrated in FIGS. 4-9:

### Example Symbolic Representation

CREDENTIALS username:${prompt} password:${prompt}
CONNECT url:“http://ixia.customer.com” apiVersion:”v1”
CHECKVERSION Server:2.4
CREATESESSION “dragon”
IMPORTFILE “c:/mydocs/myconfig” ${Session.url}
MODIFY “${Session.url}/config/xyz” ‘{name:”a name” values:[“some”,
“values”]}’
APPEND “${Session.url}/xyz/mylist” {name:”another name” value:10 }
START_PROTOCOLS
START_TRAFFIC
WAIT 30
STOP_PROTOCOLS
GETSTATS format:”CSV” stats:”*” destinationFolder:”C:/”

Returning to FIG. 3, in step 304, it is determined whether the target programming language translator is provided. If a target programming language translator is not provided, control proceeds to step 306 where the symbolic representation of the web application protocol interactions that implement the test is output to the user. If a target programming language translator is provided, control proceeds to step 308 where the symbolic representation of the web application protocol interactions is translated to a target programming language. Such translation may be performed using translator 108 illustrated in FIG. 1 or FIG. 2 and the corresponding programming language description files. In step 310, the target programming language script is output to the user. An example of a script in a target programming language (Python in this example) for the “Example Symbolic Representation” above is as follows:

### Example Resulting Script

```
  import sys,os
  import argparse
  import time
  from ixia.webapi import *
  # CREDENTIALS username:${prompt} password:${prompt}
  try:
```

username = raw_input(“username:”)
os.system(“stty -echo”)
password = raw_input(“password:”)
os.system(“stty echo”)

except Exception, e:

```
  print ″Error! Failed to get credentials from user”
  sys.exit( )
```

```
  # CONNECT url:“http://ixia.customer.com” apiVersion:”v1”
  try:
```

username = raw_input(“username:”)
os.system(“stty -echo”)
password = raw_input(“password:”)
os.system(“stty echo”)
connection = webApi.connect(″https://″+webServerAddress, version,

```
  None, user, password)
  except Exception, e:
print ″Error! Connecting to helloworld server failed! Error was: ″ + str(e)
```

sys.exit( )

```
  #CHECKVERSION Server:2.4
  serverInfo = GET /serverInfo
  if int(serverInfo.dragonVersion) < 2.4:
```

```
  print “Error! Old server version. Aborting”
  sys.exit( )
```

```
  session = connection.createSession(“dragon”)
  If session.state == “Initial”:
```

session.startSession([“some”, “values”])

try:

#IMPORTFILE “c:/mydocs/myconfig” ${Session.url}
with open(″c:/mydocs/myconfig ″, ″rb″) as importFile:
importedConfig =
session.importConfigurationFromFile(importFile)
# loading the configuration might change its name, so report

the name after import

```
  print ″Configuration %s loaded.″ %
  importedConfig.details.name
```

session.loadConfiguration(importedConfig.details.name)

# MODIFY “${Session.url}/config/xyz” ‘{name:”a name”

values:[“some”, “values”]}’

temp1 = session.httpGet(session.url+”/config/xyz”)
temp1.name = “a name”
temp.values =
session.httpPut(session.url+”/config/xyz”,

“{name:”a name” values:[“some”, “values”]}”);

# APPEND “${Session.url}/xyz/mylist”, {name:”another name”

value:10 }

session.httpPost(session.url+”/xyz/mylist”, {name:”another

name” value:10 })

#START_PROTOCOLS
session.startProtocols( )
#START_TRAFFIC
session.startTraffic( )
# WAIT 30
sleep(30)
#STOP_PROTOCOLS
session.stopProtocols( )
notifications = session.getNotifications( )
if notifications:
print “Notifications”

#GETSTATS format:”CSV” stats:”*”

stats= connection.getAvailableStats(testID)

```
for x in range(1,len (stats)):
  filePath = “C:/” + str(time.time( ))+′.csv′
  with open(filePath, ″wb+″) as statsFile:
```

requestId = ″csvRequest_″+str(x)+″_″+str(time.time(
))
csvRequest = StatsRequest(requestId, stats[x].stats)
connect.getStatsCsvToFile(testID, csvRequest,
statsFile)

except Exception, e1:

session.stopSession( )
print_exc( )

In the examples illustrated in FIGS. 4-9, the symbolic representation is generated based on user input received via a graphical user interface. In an alternate implementation, server 100 may function in a replay mode where symbolic representation generator records calls made to API 102 during a test along with the time of receipt (either relative or absolute) of each call and generates the resulting symbolic representation from the sequence of recorded calls. Such an embodiment may be useful to replicate behavior of a running server. Replay mode may also be useful for translation of a script from one programming language to another. For example, calls made to API 102 by a running server based on a test script written in one programming language may be recorded by symbolic representation generator 104, converted to the symbolic representation, and then converted to a new target programming language by translator 108.

In yet another alternate implementation of the subject matter described herein, server 100 may operate in a mixed mode where symbolic representation generator 104 initially generates a symbolic representation of REST interactions for a test based on static configuration information received via GUI 101, subsequently records actions of an executing script via calls made to interface 102, and updates the initially created symbolic representation based on the subsequently recorded inputs. The mixed mode of operation allows static test configuration commands to be generated based on user input made via GUI 101 and then the commands can be appended to with additional commands generated by the running script to replay actions performed by the running script.

In any of the modes of operation described herein, symbolic representation generator 104 can generate additional commands to perform routing tasks, such as session setup, teardown, or periodic tasks to make the resulting scripts more useful.

Thus, according to one embodiment of the subject matter described herein, a web server that tests one of more devices under test may also be used to export a programming-language-neutral symbolic representation of interactions in a web application protocol that implement a test and to automatically generate corresponding script from the symbolic representation. Such a server may also execute the scripts to test one or more devices under test. The subject matter described herein thus transforms a web server into a special purpose computing platform for automatically generating symbolic representations of web application protocol interactions that implement a test and, in some cases, test scripts in target programming languages for testing one or more devices under test. Such a web server improves the technological fields of network equipment testing and test script development.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for generating a programming-language-neutral representation of web application protocol interactions that implement a network test, the method comprising:
receiving, at a web server, test configuration information for configuring a test for testing at least one network device;
generating, based on the test configuration information, a programming-language-neutral representation of web application protocol interactions that implement the test; and
outputting the programming-language-neutral representation of the web application protocol interactions to a user or to a translator for translation into at least one target programming language.

2. The method of claim 1 wherein receiving the test configuration information includes receiving the test configuration information from a user via a graphical user interface.

3. The method of claim 1 wherein receiving the test configuration information includes recording calls made to a web application protocol application programming interface (API) and storing the recorded sequence of calls.

4. The method of claim 1 wherein receiving the test configuration information includes receiving the test configuration information from a user via a graphical user interface and from recording calls made to a web application protocol application programming interface (API) and wherein generating the programming-language-neutral representation includes generating an initial representation from the test configuration information received via the GUI and appending the recorded calls to the initial representation.

5. The method of claim 1 wherein receiving the test configuration information includes receiving information regarding network traffic to be generated and sent to a device under test.

6. The method of claim 1 wherein generating the programming-language-neutral representation of the web application protocol interactions includes generating a symbolic representation of representational state transfer (REST) protocol interactions.

7. The method of claim 1 comprising providing a translator and at least one programming language description file for translating the programming-language-neutral representation into the at least one target programming language.

8. The method of claim 7 wherein providing the translator includes providing the translator on the web server.

9. The method of claim 7 wherein providing the translator includes providing the translator separate from the web server.

10. The method of claim 7 wherein providing the translator includes providing a programming-language-neutral translator engine and a plurality of different programming language description files that translate the programming-language-neutral representation into a plurality of different target scripting programming languages.

11. The method of claim 7 wherein outputting the programming-language-neutral representation includes outputting the representation to the translator, which translates the representation into the at least one target programming language.

12. The method of claim 1 comprising providing a plurality of programming-language-specific translators for translating the programming-language-neutral representation into a plurality of different programming languages.

13. The method of claim 1 wherein outputting the programming-language-neutral representation includes outputting the programming-language-neutral representation to a user.

14. The method of claim 1 wherein the at least one target programming language comprises at least one target scripting language.

15. A system for generating a programming-language-neutral representation of web application protocol interactions that implement a network test, the system comprising:
a web server for receiving test configuration information for configuring a test for testing at least one network device; and
a symbolic representation generator for generating, based on the test configuration information, a programming-language-neutral representation of web application protocol interactions that implement the test and outputting the programming-language-neutral representation of the web application protocol interactions to a user or to a translator for translation into at least one target programming language.

16. The system of claim 15 wherein the web server includes a graphical user interface for receiving the test configuration information from the user.

17. The system of claim 15 wherein the web server includes a web application protocol application programming interface (API) and wherein the symbolic representation generator is configured to record calls made to the web application protocol API and store the recorded sequence of calls as the test configuration information.

18. The system of claim 15 wherein the web server includes a graphical user interface for receiving the test configuration information from a user via a graphical user interface and an web application protocol application programming interface (API) and wherein the symbolic representation generator is configured to generate the programming-language-neutral representation by creating an initial representation an initial representation from the test configuration information received via the GUI and appending the recorded calls to the initial representation.

19. The system of claim 15 wherein the test configuration information includes information regarding network traffic to be generated and sent to a device under test.

20. The system of claim 15 wherein the programming-language-neutral representation of the web application protocol interactions comprises a representation of representational state transfer (REST) protocol interactions.

21. The system of claim 15 comprising a translator and at least one programming language description file for translating the programming-language-neutral representation into the at least one target programming language.

22. The system of claim 21 wherein the translator is located on the web server.

23. The system of claim 21 wherein the translator is separate from the web server.

24. The system of claim 21 wherein the translator includes a programming-language-neutral translator engine and the system further comprises a plurality of different programming language description files that translate the programming-language-neutral representation into a plurality of different target programming languages.

25. The system of claim 15 comprising a plurality of programming-language-specific translators for translating the programming-language-neutral representation into a plurality of different programming languages.

26. The system of claim 15 wherein the symbolic representation generator is configured to output the programming-language-neutral representation to the translator, which translates the representation into the at least one target programming language.

27. The system of claim 15 wherein the symbolic representation generator is configured to output the programming-language-neutral representation to a user.

28. The system of claim 15 wherein the at least one target programming language comprises at least one target scripting language.

29. A non-transitory computer readable medium having stored thereon executable instructions that when executed by the processor or computer control the computer to perform steps comprising:
receiving, at a web server, test configuration information for configuring a test for testing at least one network device;
generating, based on the test configuration information, a programming-language-neutral representation of web application protocol interactions that implement the test; and
outputting the programming-language-neutral representation of the web application protocol interactions to a user or to a translator for translation into a target programming language.
